(19) United States
(12) Patent Application Publication
(10) Pub. No.: US 2014/0089041 A1
(43) Pub. Date: Mar. 27, 2014

(54) TWO SIGMA INTELLIGENCE

(71) Applicant: BANK OF AMERICA CORPORATION, Charlotte, NC (US)

(72) Inventors: Arya Kumar Vedabrata, Bhubaneswar (IN); Aditya Panini Karri, Hyderabad (IN); Chandrasekhar Katuri, Hyderabad (IN); Parul Bajaj, Hyderabad (IN); Santosh Maddila, Shaikpet (IN)

(73) Assignee: BANK OF AMERICA CORPORATION, Charlotte, NC (US)

(21) Appl. No.: 13/628,361

(22) Filed: Sep. 27, 2012

(51) Int. Cl. G06Q 30/02

(52) U.S. Cl. 705/7.29

(57) ABSTRACT

Apparatus for identifying misclassified customers in a customer database is provided. The apparatus may include a receiver configured to receive information corresponding to a plurality of customers and information corresponding to a plurality of transactions. The apparatus may additionally include a processor configured to calculate a mean transaction value and a standard deviation from the mean transaction value, wherein the mean transaction value is calculated using the plurality of transactions. The processor may be further configured to identify a subset of customers included in the plurality of customers and modify at least a portion of the electronic classifications of the subset of customers. The modification may include changing an individual customer classification to a small business or preferred customer classification.

### FIELD OF TECHNOLOGY

This invention relates to a tool for use in identifying and targeting a group of customers.

### BACKGROUND OF THE DISCLOSURE

A business typically desires to offer products and services to existing customers. However, a business with limited resources may desire to initially target a subset of customers most likely to respond positively to offers for products and services.

It would be desirable, therefore, to provide systems and methods for processing business customer data and identifying a subset of customers relatively more likely to respond positively to offers for products and services.

Additionally, a business may offer products and services to a customer based on the business's internal classification of the customer. For example, the business may offer a first group of products to a customer classified as an ‘individual’ customer and a second group of products to a customer classified as a ‘small business’ customer.

However, a business's internal classification may be incorrect. This is not desirable at least because incorrect customer classifications may result in lost business opportunities. These lost business opportunities may take the form of losing the opportunity to offer potentially desirable products to customers.

It would be further desirable, therefore, to provide systems and methods for updating a business's internal customer classifications.

### SUMMARY OF THE DISCLOSURE

A method for identifying misclassified customers in a customer database is provided. The method may include using a receiver to receive information corresponding to a plurality of customers. The method may further include using a receiver to receive information corresponding to a plurality of transactions. The method may also include using a processor to calculate a mean transaction value and a standard deviation from the mean transaction value. The mean transaction value may be calculated using the plurality of transactions. The method may further include using the processor to identify a subset of customers included in the plurality of customers. Each of the customers included in the subset of customers may be customers who have spent, during a predetermined time period, a total value of funds equal to or greater than a two sigma transaction value. The two sigma transaction value may be equal to the mean transaction value plus twice the standard deviation from the mean transaction value. The method may additionally include using the processor to modify at least a portion of the electronic classifications of the subset of customers. The modification may include changing an individual customer classification to a small business classification.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows an illustrative representation of a breakdown of National Gross Domestic Product;

FIG. 3 shows an exemplary non-Gaussian distribution;

FIG. 4 shows a hybrid system and method in accordance with the systems and methods of the invention;

FIG. 5 shows a graphical display that may be output by the systems and methods of the invention; and

FIG. 6 shows yet another graphical display that may be output by the systems and methods of the invention.

### DETAILED DESCRIPTION OF THE DISCLOSURE

The systems and methods of the invention relate to assisting a business in targeting customers likely to respond positively to business offers. The systems and methods of the invention additionally relate to modifying, in a database, information corresponding to the classification(s) of one or more customers. The invention may include a two sigma intelligence engine (referred to alternately hereinafter as a ‘2σI engine’). The 2σI engine may process customer data and identify customers likely to respond positively to business offers and/or identify customers who may benefit from a modification of their customer classifications.

The 2σI engine may have electronic access to one or more databases. The one or more databases may store customer information relating to each of a plurality of customers. Exemplary customer information may include transactions executed by a customer and personal customer data such as the customer's address, age, and occupation.

The 2σI engine may calculate an average amount of money spent by a group of customers during a predetermined time period (referred to alternately hereinafter as ‘average customer spending’). The predetermined time period may be daily, weekly, bi-weekly, monthly and/or any other suitable time period. For the purposes of this application, the average customer spending may also be referred to alternately as ‘mean customer spending’ or ‘μ.’

The group of customers may be a subset of the plurality of customers included in the database(s) or all customers included in the database(s). Exemplary groups of customers include customers classified as ‘individual/individual customers,’ ‘preferred customers’ ‘small business customers’ and/or ‘large business customers.’ It should be noted that these classifications are exemplary only. Any business classification(s) used by a business to classify their customers may be suitable to define a group of customers according to the systems and methods of the invention. Additional customer groups may include one or more of: consumers, businesses and/or government agencies.

The 2σI engine may calculate the average customer spending using some or all of the transaction data associated with each of the customers included in the group of customers. In some embodiments, the transaction data may correspond to some or all of the transactions executed by the group of customers during a predetermined time period.

The transaction data used to calculate the average customer spending may include transactions involving inbound and/or outbound transfers of funds. Exemplary inbound transfers of funds include transfers of funds from other banks or bank accounts, cash deposits, check deposits, PayPal deposits and ACH automatic deposits. Exemplary outbound transfers of funds include cash withdrawals, credit card payments, debit card payments, PayPal payments, check payments and automatic ACH withdrawals.

In some embodiments, the transaction data used by the 2σI engine to calculate the average customer spending may correspond to transactions executed by the group of customers during a predetermined time period that fall into one or more ‘transaction buckets.’ For the purposes of this invention, a transaction bucket may relate to one or more characteristics of a customer transaction and transactions that fall into (or ‘are included in’) the transaction bucket may correspond to executed customer transactions that include the characteristic(s).

In some embodiments, a characteristic of a transaction bucket may be a Merchant Category Code (“MCC”) and/or an industry code. In some of these embodiments, all transactions that include the MCC and/or industry code associated with the transaction bucket may be determined to be included in the transaction bucket.

It should be noted that an Industry code may relate to a four digit code defined by a governmental body and used to classify industries. Additionally, it should be noted that an MCC code may be a code assigned to a business by MasterCard™ or Visa™ which classifies business by the type of goods and services provided.

Additional exemplary characteristics of a transaction bucket may include one or more of the following: car loan payments, credit card payments, cash withdrawals, education payments, gas station payments, jewelry store payments, lawyer/law firm payments, savings payments, tax payments, utility payments, clothing payments, auto payments and sports payments/payments for a specific type of a sport. Further characteristics of a transaction bucket may include one or more of: consumer spending, government spending and/or business spending.

It should be noted that the systems and methods of the invention include transaction buckets that are associated with one or more of the aforementioned exemplary characteristics, in addition to any other suitable characteristic.

For example, the 2σI engine may calculate average customer spending for a ‘car loan’ transaction bucket. The 2σI engine may execute this calculation by retrieving, from one or more databases, all transactions executed by the group of customers during a predetermined time period that are associated with car loans. In some embodiments, credit card transactions with a MCC code or an Industry code relating to car loans may be retrieved, in addition to any PayPal payments, electronic transfers and/or other customer transactions that include a description relating to a car loan.

The 2σI engine may calculate the average customer spending by summing a value of each transaction included in the transaction data and dividing the resultant sum by a total number of customers included in the group of customers. This calculation may be represented by the equation μ=(Σᵢ₋₁ⁿαₐ)/x, where n corresponds to a total number of transactions included in the transaction data, αᵢ corresponds to a transaction value associated with an i^{th} transaction included in the transaction data and x corresponds to the total number of customers included in the group of customers.

In some embodiments, the 2σI engine may also calculate an average customer transaction frequency. The average customer transaction frequency may be calculated by the equation: (a total number of transactions included in the transaction data)/(a total number of customers included in the group of customers). It should be noted that some or all of the manipulations applied by the 2σI engine to the average customer spending, including calculating a standard deviation from the average customer spending, a 2σ value, etc., may also be applied to the average customer transaction frequency.

After calculation of the average customer spending, the 2σI engine may determine a standard deviation. The standard deviation may be a standard deviation from the average customer spending. The standard deviation may alternately be referred to as ‘variation from the mean,’ ‘square root of the variance of the data set,’ or ‘σ.’

The 2σI engine may subsequently calculate a 2σ value. The 2σ value may be calculated at least in part by multiplying the standard deviation by two. It should be noted that, in some embodiments, the 2σI engine may calculate a normalized average customer spending, a normalized standard deviation and/or a normalized 2σ value. In some of these embodiments, the normalized 2σ value may be calculated at least in part by the equation: 2σ/μ.

In the embodiments wherein the 2σI engine has calculated an average customer spending for a group of customers, the 2σ value may correspond to two standard deviations away from the average customer spending of the group of customers. In some embodiments, the 2σI engine may subsequently determine which customers in the group of customers have spent a total value of funds during the predetermined time period that is equal to or greater than: (average customer spending)+(2σ value). These customers may be electronically identified as exhibiting 2σ behavior. In other embodiments, the 2σI engine may subsequently determine which customers in the group of customers have spent a total value of funds during the predetermined time period that is equal to or greater than: (average customer spending)+(2σ value)±(adjustment number). In these embodiments, these customers may be electronically identified as exhibiting 2σ behavior. It should be noted that the adjustment number may be any suitable value.

In the embodiments wherein the 2σI engine has calculated an average customer spending for a transaction bucket, the 2σ value may correspond to two standard deviations away from the average customer spending associated with the transaction bucket. In some embodiments, the 2σI engine may subsequently determine which customers in the group of customers have spent a total value of funds associated with the transaction bucket during the predetermined time period that is equal to or greater than: (average customer spending associated with the transaction bucket)+(2σ value). These customers may be electronically identified as exhibiting 2σ behavior. In other embodiments, the 2σI engine may subsequently determine which customers have spent a total value of funds associated with the transaction bucket that is equal to or greater than: (average customer spending associated with the transaction bucket)+(2σ value)±(adjustment number). In these embodiments, these customers may be electronically identified as exhibiting 2σ behavior.

Upon identification of customers exhibiting 2σ behavior, the 2σI engine may classify these customers as 2σ customers in one or more databases. The 2σI engine may subsequently take one or more forms of action (referred to alternately hereinafter as a ‘2σ action’).

Exemplary 2σ action may include automatically updating customer information relating to the 2σ customers. In some embodiments, in the event that the group of customers are electronically classified as ‘customers,’ the 2σI engine may change the electronic classifications of the 2σ customers from ‘customer’ to ‘preferred customer’. In other embodiments, in the event that the group of customers are electronically classified as ‘individual customers,’ the 2σI engine may change the electronic classifications of the 2σ customers from ‘individual customer’ to ‘small business.’

Additional exemplary 2σ action may include modifying products and services offered to the 2σ customers via e-mail, text, mail or in person at a banking institution. Further 2σ action may include modifying the frequency and/or the level of engagement with which products and/or services are offered to the 2σ customers. For example, in some embodiments, a treatment engagement strategy at 2σ levels may include a high level of engagement.

Alternately, in some embodiments, subsequent to the electronic identification of customers exhibiting 2σ behavior by the systems and methods of the invention, the 2σI engine may refine and validate customer data corresponding to these customers. For example, the 2σI engine may analyze other transactions and/or personal information associated with these customers prior to electronically categorizing the customers as 2σ customers. It should be noted that the analysis may or may not include flagging the customers exhibiting 2σ behavior for manual review.

In some embodiments, the 2σI engine may access ratings associated with the customers exhibiting 2σ behavior. The ratings may relate to the net worth of the customers based on where he/she lives/works/position at work/spending/etc. The 2σI engine may use the ratings and/or information used to obtain the ratings to determine whether or not to electronically classify each customer exhibiting 2σ behavior as a 2σ customer.

In some embodiments, in the event that the 2σI engine has identified a customer who exhibits 2σ behavior with respect to a transaction bucket, the 2σI engine may determine if the customer's transaction data in other transaction bucket(s) are at or above a predetermined value and/or a 2σ value. In these embodiments, the 2σI engine may use the other transaction data to determine whether or not to classify the customer as a 2σ customer.

In yet other embodiments, the 2σI engine may access one or more databases for additional information relating to potential 2σ customers (i.e. customers exhibiting 2σ behavior) and/or request a third party for additional information relating to the potential 2σ customers. For example, the 2σI engine may review information relating to a potential 2σ customer's employment, residence, age, total assets, media coverage relating to the potential 2σ customer, and/or any other suitable customer information. This data may be used to assist in determining whether or not to classify a potential 2σ customer as a 2σ customer.

The 2σI engine may analyze the aforementioned information and any other suitable information to determine whether or not to classify a potential 2σ customer as a 2σ customer in one or more databases. For example, in the event that one or more pieces of data indicate the potential 2σ customer's high value of spending, high volume of spending and/or individual prominence (personal or in business), the 2σI may subsequently classify the potential 2σ customer as a 2σ customer in one or more databases.

For example, a customer may be determined to be a potential 2σ customer because a total amount of funds that he has spent, during a predetermined time period, on vehicles, hardware stores and gasoline, is equal to or has exceed the 2σ values associated with the transaction buckets for vehicle transactions, hardware store transactions and gasoline transactions. The 2σI engine may subsequently search databases for additional information relating to the 2σ customer and determine that the customer is president of a company that exports auto parts, cars and trucks. This determination may be sufficient for the 2σI engine to modify the 2σ customer's internal classification from an individual customer classification to a small business customer classification.

In some embodiments, in the event that a potential 2σ customer is not associated with any other data that points to statistically significant customer behavior, the 2σI engine may take no further action regarding the potential 2σ customer. In other embodiments, in the event that a potential 2σ customer is not associated with any other statistically significant data, the 2σI engine may monitor the potential 2σ customer's behavior during a predetermined time period to determine if he has generated any data pointing to his 2σ status. If he has generated data pointing to his 2σ status, the potential 2σ customer may be classified as a 2σ customer. If not, the 2σI engine may take no further action regarding the potential 2σ customer.

In these embodiments, in the event that the 2σI engine classifies a potential 2σ customer as a 2σ customer after processing and/or refining the 2σ customer data, the 2σI engine may subsequently take one or more forms of 2σ action for the classified 2σ customers.

In some embodiments of the invention, the 2σI engine may periodically identify customers with 2σ transaction behavior upon the lapse of a predetermined time period and store the identified 2σ customers in a database. For example, the 2σI engine may process transaction data executed by a group of customers during a first calendar month and identify 2σ customers who have manifested the requisite transaction behavior. Subsequently, upon the lapse of a second month, the 2σI engine may again identify 2σ customers by processing transaction data generated during the second month.

In some of these embodiments, a customer may be required to exhibit 2σ behavior for a predetermined time period (for example, two or more months) prior to the 2σI engine taking any 2σ action for the customer and/or further analyzing potential 2σ customer data. For example, the 2σI engine may use a moving window of analysis to determine if a customer has exhibited 2σ behavior for the predetermined time period. This is desirable at least because there may be customers who exhibit 2σ behavior for a short period of time, but do not consistently manifest statistically significant behavior. To illustrate, an otherwise low-spending customer may spend a lot of money on jewelry prior to his wedding. Therefore, having a requisite predetermined time period for exhibiting consistent 2σ behavior assists the 2σI engine in classifying, as 2σ customers, only those customers whose behavior is consistently different from a consumer norm.

For example, the systems and methods of the invention may determine if a customer has exhibited 2σ behavior at the beginning of each month. If he has, this data may be stored in a database. In the event that the customer is determined to have exhibited 2σ behavior for three consecutive months, the 2σI engine may classify the customer as a 2σ customer and take 2σ action and/or further process/analyze data associated with the customer.

Furthermore, in some embodiments, in the event that a customer has been classified as a 2σ customer and subsequently ceases to exhibit 2σ behavior, the 2σI engine may delete the customer's 2σ status from a database and/or revert any 2σ action that was taken by the 2σ engine. It should be noted that a 2σ customer may be required to exhibit behavior below a 2σ threshold for a predetermined period of time prior to the 2σI engine's deletion the 2σ customer's status from one or more databases.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the 2σI engine may be embodied as a method, a data processing system, or a computer program product. Accordingly, the 2σI engine may take the form of an entirely hardware embodiment, an entirely software embodiment or an embodiment combining software and hardware aspects.

Furthermore, the 2σI engine may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, in the event that the 2σI engine is embodied at least partially in hardware, the 2σI engine may include one or more databases, receivers, transmitters, processors, modules including hardware and/or any other suitable hardware. Furthermore, the operations executed by the 2σI engine may be performed by the one or more databases, receivers, transmitters, processors and/or modules including hardware.

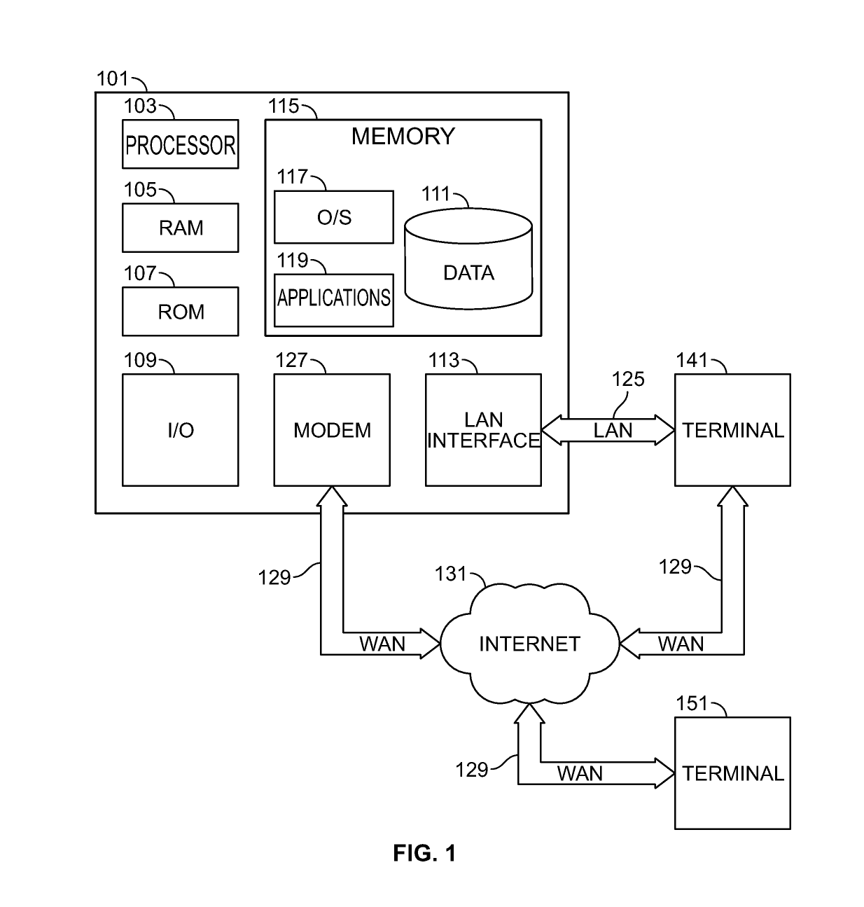

FIG. 1 is a block diagram that illustrates a generic computing device 101 (alternately referred to herein as a “server”) that may be used according to illustrative embodiments of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or database 111 to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for customer information relating to a plurality of customers and database 111 may be accessible to the 2σI engine.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a business representative to access and/or input information into the 2σI engine. Transactional information, customer information, 2σ customer information, 2σ action and/or any other information utilized by the 2σI engine may be stored in memory 115 and/or in another memory located separately from memory 115. It should be noted that the stored information stored in memory 115 or in another memory located separately from memory 115 may be processed by an application such as one of applications 119. An exemplary application 119 may be an application that implements one or more of the functionalities of the 2σI engine.

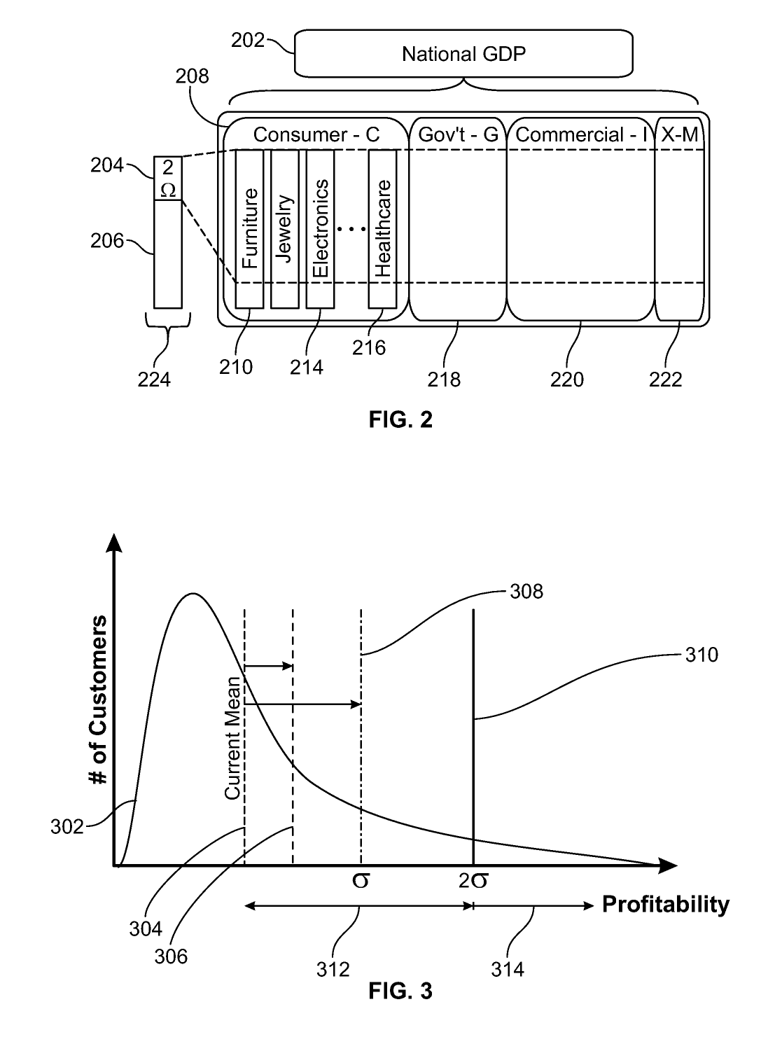

FIG. 2 shows an illustrative breakdown of National Gross Domestic Product (“GDP”) 202. The GDP may include transaction buckets Consumer—C Spending 208, Government—G Spending 218, Commercial—I Spending 220 and Additional X-M Buckets 222. One or more of the transaction buckets may be broken down into additional transaction buckets. For example, Consumer—C Spending 208 may include transaction buckets Furniture 210, Jewelry 212, Electronics 214 and Healthcare 216.

FIG. 2 may additionally include Representative Population Bar 224. Representative Population Bar 224 may include 2σ Customers 204 and Non-2σ Customers 206. Representative Population Bar 224 may illustrate that National GDP 202 is controlled mainly by 2σ Customers 204. Specifically, Representative Population Bar 224 illustrates that approximately 80% of the transactions included in the GDP buckets are being generated by 2σ Customers 204. This illustrates the importance of 2σ Customers 204 and their influence on National GDP 202. Additionally, because 2σ Customers 204 are the main driving force for National GDP 202, it follows that identifying 2σ Customers 204 may assist businesses in prioritizing who to target for advertisement of products and services, in addition to a level of engagement appropriate for 2σ Customers 204.

FIG. 3 shows exemplary Distribution 302 that may be calculated by the 2σI engine. Distribution 302 may be a non-Gaussian distribution. It should be noted that a distribution calculated by the 2σI engine may be a Gaussian distribution, a non-Gaussian distribution or a non-normal distribution.

Distribution 302 may graph each customer included in a group of customers relative to their profitability—i.e. a total amount of funds spent by the customer during a predetermined time period. Current Mean 304 may illustrate an average value of funds spent by the group of customers during a predetermined time period (referred to by the systems and methods of the invention as an ‘average customer spending’). New Mean 306 may illustrate a potential new average customer spending for Distribution 302 in the event that more customers plotted as Average Customers 312 are added to Distribution 302. New Mean 308 may illustrate a potential new average customer spending for Distribution 302 in the event that more customers plotted as 2σ Customers 314 are added to Distribution 302. It should be noted that 2σ Customers 314 may be customers whose total amount of spending during the predetermined time period is equal to or greater than Two Standard Deviations 310 away from Current Mean 304.

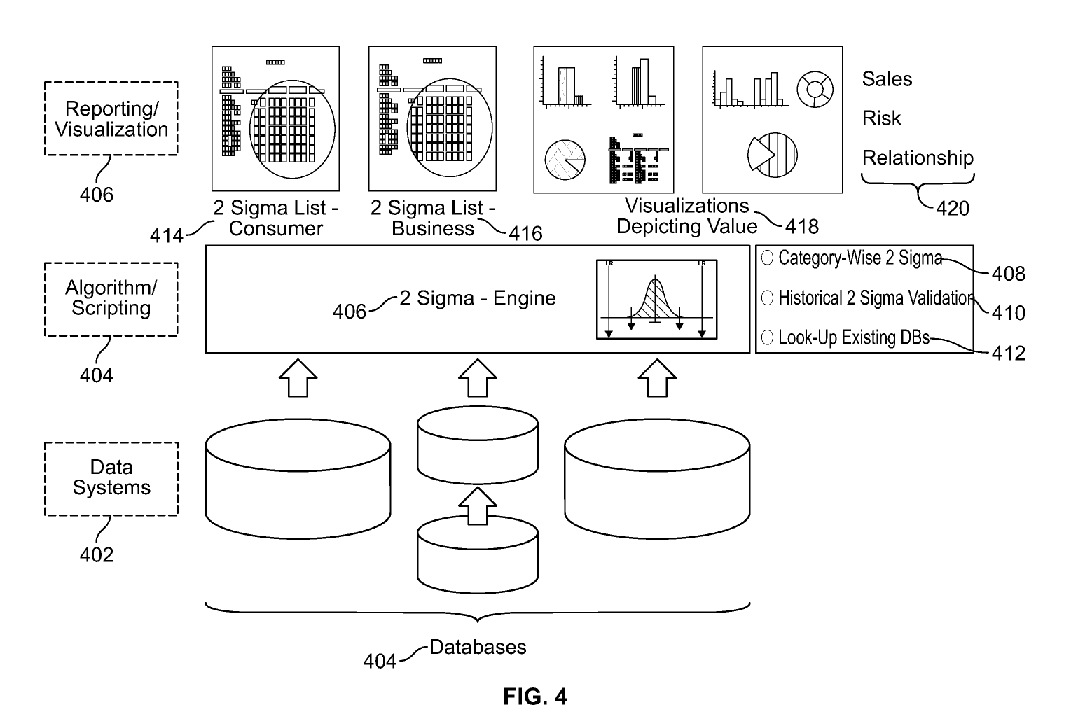

FIG. 4 shows an illustrative hybrid system and method in accordance with the systems and methods of the invention. In the illustrative hybrid system and method, 2σI Engine 406 may access Data Systems 402. Data Systems 402 may include one or more of Databases 404.

I Engine 406 may also execute one or more Algorithms/Scripting 404. For example, 2σI Engine 406 may calculate Category-Wise 2σ 408. Category-Wise 2σ 408 may include identifying 2σ customers for one or more transaction buckets. 2σI Engine 406 may additionally execute Historical 2σ Validation 410. Historical 2σ Validation 410 may include using historical customer data to determine whether a potential 2σ customer has exhibited other statistically significant behavior(s). 2σI Engine 406 may further execute Look-Up Existing DBs (Data Bases) 412. Look-Up Existing DBs 412 may include searching existing databases to determine whether a potential 2σ has previously been characterized as a 2σ customer and/or accessing potential 2σ customer data relating to the customer's financial status, occupation, residence and/or any other suitable data.

2σI Engine 406 may additionally output Reporting/Visualization 406. Exemplary data output by 2σI Engine 406 may include 2σ List—Consumer 414 and 2σ List—Business 416, which may respectively display a list of the 2σ Consumers and the 2σ Businesses identified by 2σI Engine 406. Additional data output by the 2σI Engine may include Visualizations Depicting Value 418. Visualizations Depicting Value 418 may include one or more charts, lists, graphs or any other visual representations of 2σ Customer Data. It should be noted that the data output by the 2σI Engine 406 may be used by a business to analyze potential Sales, Risk and Relationships 420.

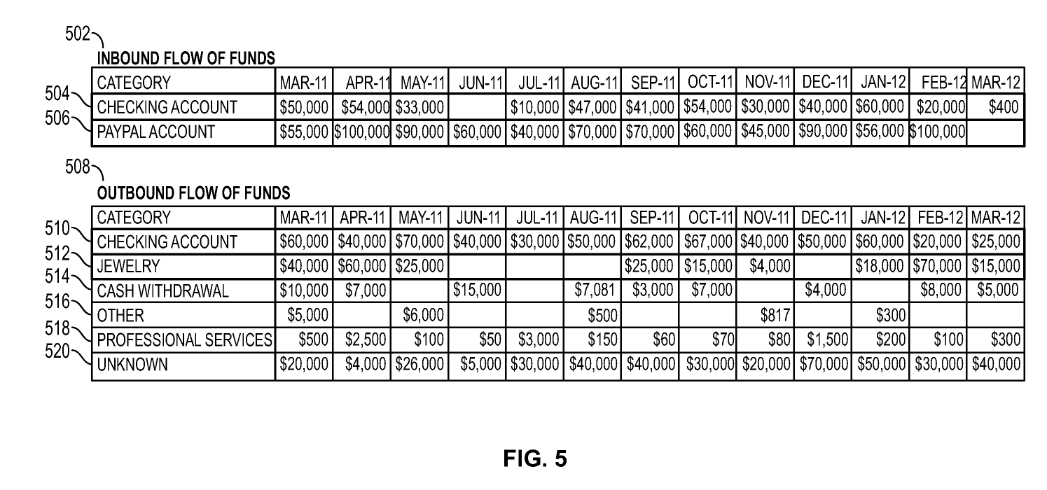

FIG. 5 shows a graphical display that may be output by the 2σI engine. The graphical display illustrated in FIG. 5 may relate to a customer's Inbound Flow of Funds 502 and Outbound Flow of Funds 508. Inbound Flow of Funds 502 may include all funds input into the customer's Checking Account 504 and Paypal Account 506 between the months of March 2011 and March 2012.

Outbound Flow of Funds 508 may include all outbound funds withdrawn from one or more customer accounts between the months of March 2011 and March 2012. Outbound Flow of Funds 508 may group the outbound funds into the following categories: Checking Account 510, Jewelry 512, Cash Withdrawal 514, Other 516, Professional Services 518 and Unknown 520. It should be noted that the following information may be pulled from one or more databases that store customer transaction information.

The customer analyzed in FIG. 5 may be determined by the 2σI engine to have consistent 2σ spending in the category Jewelry 512. The 2σI engine may subsequently query one or more databases to obtain additional information relating to the customer. Additional obtained information may state that the customer is affiliated with a jewelry store and/or website. The 2σI engine may subsequently determine that the customer is a 2σ customer.

Upon identification of the customer as a 2σ customer, the 2σI engine may access a customer identifier relating to the 2σ customer. In the event that the customer identifier corresponds to an individual customer identifier, the 2σI engine may modify the customer identifier to correspond to a small business identifier or a preferred customer identifier.

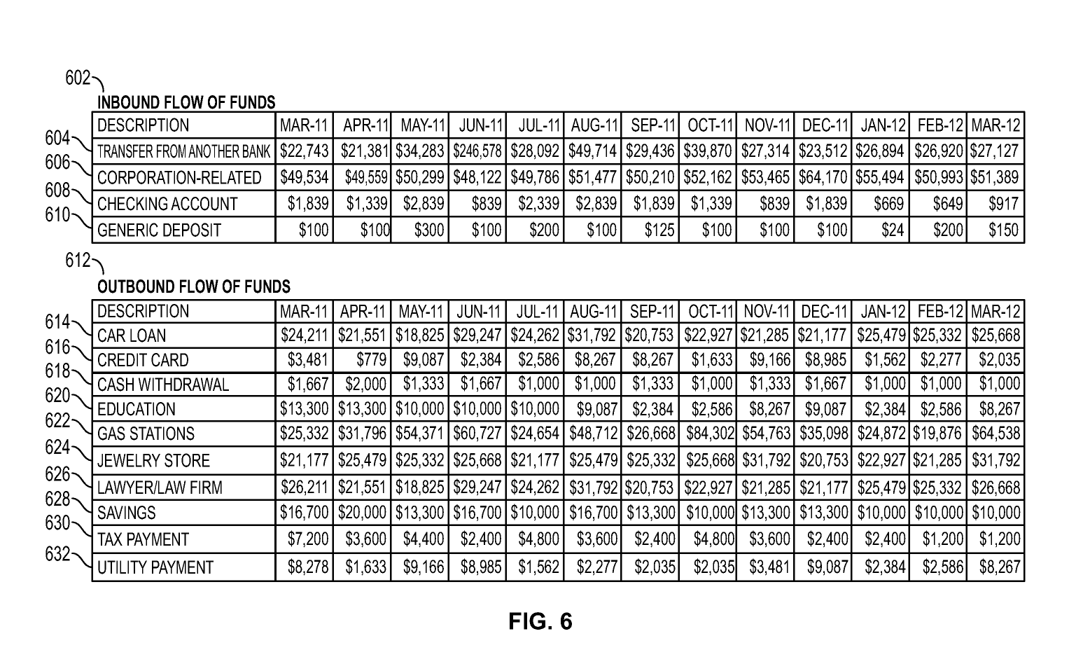

FIG. 6 shows yet another graphical display that may be output by the 2σI Engine. The graphical display displayed in FIG. 6 may relate to a customer's Inbound Flow of Funds 602 and Outbound Flow of Funds 612. Inbound Flow of Funds 602 may include all funds deposited in the customer's Checking Account 608 and Transferred from Another Bank 604, in addition to Generic Deposit 610 and Corporation-Related (Deposits) 606. The Inbound Flow of Funds 602 may relate to all inbound flows of funds in the aforementioned categories that occurred between the months of March 2011 and March 2012.

Outbound Flow of Funds 612 may include all outbound funds withdrawn from one or more customer accounts between the months of March 2011 and March 2012. Outbound Flow of Funds 612 may group the outbound funds into the following categories: Car Loan 614, Credit Card 616, Cash Withdrawal 618, Education 620, Gas Stations 622, Jewelry Store 624, Lawyer/Law Firm 62σ, Savings 628, Tax Payment 630 and Utility Payment 632. It should be noted that the following information may be pulled from one or more databases that store customer transaction information.

The customer analyzed in FIG. 6 may be determined by the 2σI engine to have consistent 2σ spending in the categories Car Loan 614 and Gas Stations 622. The 2σI engine may subsequently query one or more databases to obtain additional information relating to the customer. Additional obtained information may state that the customer is the president of an auto importing business. The 2σI engine may subsequently determine that the customer is a 2σ customer.

Upon identification of the customer as a 2σ customer, the 2σI engine may access a customer identifier relating to the 2σ customer. In the event that the customer identifier is an individual identifier, the 2σI engine may modify the customer identifier to correspond to a small business identifier.

Thus, methods and apparatus for identifying and targeting customers in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. Apparatus for identifying misclassified customers in a customer database, the apparatus comprising:
a receiver configured to receive information corresponding to a plurality of customers, wherein each of the plurality of customers are electronically classified as an individual customer in a database;
the receiver being further configured to receive information corresponding to a plurality of transactions, wherein each of the plurality of transactions corresponds to a transaction executed by one of the plurality of customers during a predetermined time period;
a processor configured to calculate a mean transaction value and a standard deviation from the mean transaction value, wherein the mean transaction value is calculated using the plurality of transactions;
the processor being further configured to identify a subset of customers included in the plurality of customers, wherein each of the customer included in the subset of customers are customers who have spent, during the predetermined time period, a total value of funds equal to or greater than a two sigma transaction value, wherein the two sigma transaction value is equal to the mean transaction value plus twice the standard deviation; and
the processor being further configured to modify at least a portion of the electronic classifications associated with the subset of customers, wherein the modification includes changing the individual customer classification to a small business classification.

2. The apparatus of claim 1 wherein the processor is further configured to normalize the mean transaction value and the standard deviation.

3. The apparatus of claim 1 wherein the total value of funds are a total value of funds spent in a transaction category.

4. The apparatus of claim 3 wherein the transaction category is a jewelry transaction category.

5. The apparatus of claim 3 wherein the transaction category is a gasoline transaction category.

6. The apparatus of claim 1 wherein the predetermined time period is a one month time period.

7. The apparatus of claim 1 wherein the receiver is further configured to receive information relating to the subset of customers, wherein the information received includes information relating to the employment, place of residence and estimated net worth of each of the subset of customers.

8. One or more non-transitory computer-readable media storing computer-executable instructions which, when executed by a processor on a computer system, perform a method for identifying misclassified customers in a customer database, the method comprising:
using a receiver to receive information corresponding to a plurality of customers;
using the receiver to receive information corresponding to a plurality of transactions, wherein each of the plurality of transactions corresponds to a transaction executed by one of the plurality of customers during a predetermined time period;
using a processor to calculate a mean transaction value and a standard deviation from the mean transaction value, wherein the mean transaction value is calculated using the plurality of transactions; and
using the processor to identify a subset of customers included in the plurality of customers, wherein each of the customer included in the subset of customers are customers who have spent, during the predetermined time period, a total value of funds equal to or greater than a two sigma transaction value, wherein the two sigma transaction value is equal to the mean transaction value plus twice the standard deviation.

9. The computer-readable media of claim 8 wherein, in the method, the processor is further configured to normalize the mean transaction value and the standard deviation.

10. The computer-readable media of claim 8 further comprising using a storage module to store information corresponding to the subset of customers.

11. The computer-readable media of claim 8 wherein, in the method, the processor:
identifies an additional subset of customers upon the lapse of a predetermined time period; and
stores information corresponding to the additional subset of customers in a database.

12. The computer-readable media of claim 11 wherein, in the method, the processor is further configured to modify the electronic classification for each customer included in the plurality of customers who has been included in both the subset of customers and the additional subset of customers.

13. The computer-readable media of claim 8 wherein, in the method, the processor is further configured to query one or more databases for personal information corresponding to the subset of customers, wherein the personal information includes a place of employment and place of residence.

14. The computer-readable media of claim 8 wherein, in the method, the total value of funds are a total value of funds spent in a transaction category.

15. The computer-readable media of claim 8 wherein, in the method, the processor is further configured to modify, for the subset of customers, electronic data relating to products and services electronically transmitted to the subset of customers.

16. Apparatus for identifying misclassified customers in a customer database, the apparatus comprising:
a receiver configured to receive information corresponding to a plurality of customers;
the receiver being further configured to receive information corresponding to a plurality of transactions, wherein each of the plurality of transactions corresponds to a transaction executed by one of the plurality of customers during a predetermined time period;
a processor configured to calculate a mean transaction value and a standard deviation from the mean transaction value, wherein the mean transaction value is calculated using the plurality of transactions; and
the processor being further configured to identify a subset of customers included in the plurality of customers, wherein each of the customer included in the subset of customers are customers who have spent, during the predetermined time period, a total value of funds equal to or greater than a two sigma transaction value, wherein the two sigma transaction value is calculated by the equation: (mean transaction value)+2*(standard deviation)±(adjustment value).

17. The apparatus of claim 16 wherein each of the plurality of customers are electronically classified as an individual customer in a database.

18. The apparatus of claim 17 wherein the processor is further configured to modify at least a portion of the electronic classifications associated with the subset of customers, wherein the modification includes changing the individual customer classification to a preferred customer classification.

19. The apparatus of claim 16 wherein the receiver is further configured to receive information relating to the subset of customers, wherein the information received includes information relating to the employment, place of residence and estimated net worth of each of the subset of customers.

20. The apparatus of claim 16 wherein the processor is further configured to modify an electronic algorithm, wherein the modification alters the products and services electronically generated and transmitted to the subset of customers.
